(19) United States
(12) Patent Application Publication
(10) Pub. No.: US 2026/0367975 A1
(43) Pub. Date: Nov. 19, 2026

(54) ADAPTIVE CONSTRAINT RELAXATION FOR DETERMINING PLACEMENT OF SERVICE INSTANCES ONTO DISTRIBUTED RESOURCE NODES

(71) Applicant: Telefonaktiebolaget LM Ericsson (publ), Stockholm (SE)

(72) Inventors: Róbert SZABÓ, BUDAPEST (HU); Carla MOURADIAN, MONTREAL (CA); Ákos RECSE, HALASZTELEK (HU); Wubin LI, KIRKLAND (CA)

(21) Appl. No.: 19/133,542

(22) PCT Filed: Dec. 2, 2022
(86) PCT No.: PCT/EP2022/084309

§ 371 Date: May 28, 2025

(51) Int. Cl. G06F 9/50

(52) U.S. Cl. CPC G06F 9/5027

(57) ABSTRACT

A method determines placement of services on distributed resource nodes, and includes obtaining operating constraints for the services and node resource information identifying resources of the distributed resource nodes. The method determines whether the services can be placed on the distributed resource nodes without violating any of the operating constraints for the services. Based on determining the services cannot be placed on the distributed resource nodes without violating any of the operating constraints for the services, the method generates relaxed operating constraints of the services based on applying penalty values to change values of the operating constraints, where different penalty values are applied to each one of the operating constraints. The method determines a candidate placement of the services.

### TECHNICAL FIELD

The present disclosure relates to the field of determining placement of service instances onto distributed resource nodes for access by communication devices.

### BACKGROUND

In distributed cloud environments, the embedding of network service components (e.g., Virtual Network Functions “VNFs”) is non-trivial and be a nondeterministic polynomial (NP)-hard problem under constraints (e.g., considering computing and/or networking latency, cost, capability, etc.), making the problem algorithmically difficult and possibly optimally incalculable for high input sizes (large number of VNFs and/or distributed resource nodes and collective infrastructure). VNFs are some non-limiting examples of services that are described herein. This is one of the reasons automations with heuristics are needed for the service embedding problem to attempt to provide acceptable resource allocations. One tradeoff of using a heuristic-based approach is that it does not exhaustively explore and examine every possible solution, which a result in a situation where no feasible solution is provided for a given network service embedding problem. Furthermore, in some scenarios, regardless of what approach is used, it is possible that a feasible solution is not possible due to the constraints of the request.

In these cases, instead of simply giving a “no solution” answer, one alternative is to suggest adjustments/changes to the constraints so that the network service can be eventually embedded.

Reference [1] discloses an ordering heuristic (the min-conflicts heuristic) directed to constraint satisfaction problems. The main idea is in each searching step, to select a variable that is in conflict, and assign it a value that minimizes the number of conflicts until a consistent assignment is achieved. Although their approach is concise and efficient, using it to solve a general Constraint Satisfaction Problem (CSP) problem requires transforming the problem into its corresponding Guarded Discrete Stochastic (GDS) network problem, which is not straightforward. Furthermore, it is not easy to retrieve the solution of the original problem in reverse through the solution of the new problem. Thus, its applicability is limited.

Reference [2] discloses a solution for the multi-agent coordination problem. The problem is represented as distributed constraint optimization problems. The goal of solving this problem is to find a solution for all agents that minimizes the overall worst-case loss. They propose a decentralized algorithm directed to minimizing a regret function, which indicates loss because of a wrong assignment. The problem is decomposed into master and subproblem that are iteratively solved until they converged. The master problem generates a solution to minimize the maximum regret while the subproblems try to find the maximally violated constraint associated with each solution, called the witness point. This point is then added to the constraints in the master problem. The process repeats until no new witness point can be found. The computation of this solution is exponential with the number of variables in the scope, also it does not find the trade-offs between the constraints.

The Constraint Satisfaction Problem (CSP) describes some requirements for a number of variables in the form of constraints. Each variable needs to be assigned a value from a set of possible values. A constraint indicates which value tuples are allowed for a certain subset of all the variables. The solution of a CSP is an instantiation of all the variables for which all the constraints are satisfied. A CSP is solvable if it has at least one solution, otherwise, it is unsolvable or over-constrained.

Weighted CSP is a relaxation of CSP which considers a complete assignment whose constraints can be violated according to a violation degree. Constraints are considered as preferences that specify the extent of satisfaction (or violation) of associated constraints. The cost of an assignment is the sum of the evaluation of the constraints involved in all variables and an optimal solution is a complete assignment with minimum cost.

The Maximal Constraint Satisfaction Problem (MAX-CSP) is another relaxation of CSP where the goal is to find an assignment of values to all variables such that the maximum number of constraints are satisfied.

In weighted Max-CSP, each constraint is associated with a positive real value as a weight. The weighted Max-CSP approach maximizes the total sum of the satisfied constraints weights. These weights reflect the importance of the constraints, and can be used to encode the distinction between hard and soft constraints.

Reference [3] discloses adjusting penalty functions for constraint optimization problem. The operations adaptively adjust the weights of penalties (as well as the frequency of adjustment) in the process of optimization search, in order to achieve an improved solution.

Reference [4] discloses determining a placement of services after considering constraints and preferences for specified placements. The operations always adjust the most impactful constraint in each iteration, in order to find an optimal solution.

The existing approaches are too complicated to be applied to network assignment problems in real practice. For example, reference [1] requires a transformation between the original problem to the GDS network problem.

The Constraint Satisfaction Problem (CSP) does not allow constraint violation, it treats constraints as hard, meaning that they are imperative (each solution must satisfy all of them). Therefore, CSP cannot find a feasible solution when constraints violation is inevitable. There exist some flexible variant CSPs, which allow relaxing those constraints partially, e.g., weighted CSP, MAX-CSP. However, these variant CSPs require expert knowledge in the domain to express a predefined preference among the constraints and give a violation degree, those satisfying constraints with more weight are preferred.

In addition, solving weighted MAX-CSP is computationally difficult, as it is the generalization of the CSP problem, which is NP-complete. In the case of no predefined knowledge of the preference among the constraints, the problem is further extended to not only finding a feasible solution but also defining penalty function weights for the constraints systematically.

### SUMMARY

Some embodiments disclosed herein are directed to a method of determining placement of services onto distributed resource nodes. The method includes obtaining operating constraints for the services, and obtaining node resource information identifying resources of the distributed resource nodes. The method determines whether the services can be placed on the distributed resource nodes based on the node resource information without violating any of the operating constraints for the services. Based on determining the services cannot be placed on the distributed resource nodes without violating any of the operating constraints for the services, the method generates relaxed operating constraints of the services based on applying penalty values to change values of the operating constraints, and where different penalty values are applied to each one of the operating constraints. The method determines a candidate placement of the services on the distributed resource nodes based on the node resource information and the relaxed operating constraints of the services.

In an optional further embodiment, the method generates information identifying the candidate placement of which of the services on which of the distributed resource nodes and identifying which of the relaxed operating constraints of the services are violated by the candidate placement.

Some other embodiments are directed to a related service placement node that includes at least one processor and at least one memory storing instructions executable by the at least one processor to perform operations. The operations include to obtain operating constraints for the services, and to obtain node resource information identifying resources of distributed resource nodes. The operations determine whether the services can be placed on the distributed resource nodes based on the node resource information without violating any of the operating constraints for the services. Based on determining the services cannot be placed on the distributed resource nodes without violating any of the operating constraints for the services, the operations generate relaxed operating constraints of the services based on applying penalty values to change values of the operating constraints, and where different penalty values are applied to each one of the operating constraints. The operations determine a candidate placement of the services on the distributed resource nodes based on the node resource information and the relaxed operating constraints of the services.

In an optional further embodiment, the operations generate information identifying the candidate placement of which of the services on which of the distributed resource nodes and identifying which of the relaxed operating constraints of the services are violated by the candidate placement.

Potential advantages of one or more of these and other embodiments herein are that they allow constraint violation through algorithmic relaxation when placing services on distributed resource nodes, while also identifying candidate placements of which of the services on which of the distributed resource nodes and identifying which of the relaxed operating constraints of the services are violated by the candidate placement. This information can be included in constraint violation reports for planning and/or may be used to reserve operational resources of the distributed resource nodes for use during execution of the services according to the candidate placement.

Other service placement node and methods according to embodiments will be or become apparent to one with skill in the art upon review of the following drawings and detailed description. It is intended that all such service placement node and methods be included within this description, be within the scope of the present disclosure, and be protected by the accompanying claims. Moreover, it is intended that all embodiments disclosed herein can be implemented separately or combined in any way and/or combination.

### BRIEF DESCRIPTION OF THE DRAWINGS

Aspects of the present disclosure are illustrated by way of example and are not limited by the accompanying drawings. In the drawings:

FIG. 1 illustrates an example placement of three services on three distributed resource nodes with resulting operating constraint violations;

FIG. 2 illustrates an alternative placement of services A and B placed on DC E1 and service C placed on DC Central, and which would then violate the bandwidth requirement of service C;

FIG. 3 illustrates a high-level operational flow including placement optimization, generation of relaxation reports, and example uses of the reports in accordance with some embodiments;

FIG. 4 illustrates a flowchart of operations that can generate a relaxation report for placement of services on distributed resource nodes in accordance with some embodiments;

FIGS. 5A and 5B are combined to illustrate a more detailed flowchart of operations that can generate reports for placement of services on distributed resource nodes in accordance with some embodiments;

FIG. 6 illustrates a non-limiting example system in which operations disclosed herein may be performed in accordance with some embodiments;

FIG. 7 illustrates a flowchart of operations that can be performed by a service placement node in accordance with some embodiments; and

FIG. 8 illustrates a block diagram of components of a service placement node which are configured to operate in accordance with some embodiments.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of various present inventive concepts to those skilled in the art. It should also be noted that these embodiments are not mutually exclusive. Components from one embodiment may be tacitly assumed to be present/used in another embodiment.

Various embodiments of the present disclosure are directed to generating constraint relaxation or resource and/or capability extension report(s) for network service assignment, as an extension to a workload placement workflow. In cases where not all constraints can be satisfied, various embodiments operate to generate one or more reports that contain information on constraint relaxation and/or on resource and/or capability extension at specific locations of a distributed system.

The guidelines within the report(s) can be used to modify or adjust the constraints accordingly and accept the corresponding trade-off, so that the network service can be embedded.

In some embodiments, the operations include to perform programmatical modelling of constraint violation, which can include introducing a special type of penalty to represent the cost/trade-off of violating constraints. The operations further include performing a heuristic to identify multiple sets of constraint combinations with relaxing of the constraints in each set, which enables a network service to be successfully embedded and with a corresponding trade-off calculated.

If a constraint-based placement optimization fails, operations convert all (or at least some) of the constraints of the placement problem to penalty functions added to the optimization objectives. In some embodiments, the operations include to initialize penalty weights of the constraints in a way to cause each type of constraint violation to be in a different order of penalty magnitude. The operations systematically re-arrange the weights of the penalties for constraint violations so that the placement algorithm can operate to explore solutions in different preference orders of constraint violations. Each run of the placement algorithm provides a collection of locations, where resources, capabilities, and/or constraints were violated. Analysing the given service instance design: the extra resources needed (or the resource demands to be decreased); the extra capabilities needed (or to be removed from the requirements); and the quantity of link and/or path topological constraint violation (e.g., segment latency violation) can be reported.

The operations can be configured to stop the penalty weight readjustments when exploring all relative preferences of relevant constraints and when they have generated a number of recommendations which satisfies a defined rule for demand reduction or enrichment of one of more of the distributed resource nodes. Enrichment can correspond to any one or more of: increasing a number of available processor circuits and/or replacing processor circuits with higher performance processor circuits; increasing an amount of available memory capacity and/or replacing memory circuits with higher performance memory circuits and/or providing a higher performance hierarchy of memories and types of memories (e.g., increased processor cache memory, random access memory, solid-state drive, disk drive, etc.); increasing a number of network interfaces and/or replacing network interfaces with higher performance network interfaces; increasing a number of network cables and/or replacing network cables with higher performance network cables; etc. Enrichment may alternatively or additionally correspond to increasing allocation of resources that are allowed to be used by designated services from among available resources provided by distributed resource nodes and/or increasing prioritization of access by designated services to resources provided by distributed resource nodes.

Each run of the placement algorithm can identify bottlenecks in the infrastructure and can be used either to plan for infrastructure enrichments or to advise the service owner (e.g., person or computer operations) to revise some of the constraints or requirements, or any combinations of these.

As will become evident based on the following description, the operations are not limited to any specific workload placement/embedding algorithms. The operations are scalable in that they can handle cases with large size number of variables (e.g., problem with 100+ distributed resource nodes). The operations are also flexible in that they allow some violation of constraint when it is inevitable. Possible constraint violation sets can be calculated according to Pareto optimality by differently weighting constraints. Each Pareto optimality point indicates different set of constraint violations. The operations can provide automated constraint relaxation in that from the calculated constraint violation sets, requirements can be adjusted for successful deployment/assignment. The adjustment can be automated based on user-policies (e.g., identifying soft-constraints) or operational considerations. The operations can also provide improved resource upgrade planning using the constraint violation sets, where frequently identified resources and location are determined as recommendations or selections for initiating upgrades. If the operation is on top of flexible underlay resources, then upgrades can be automated accordingly.

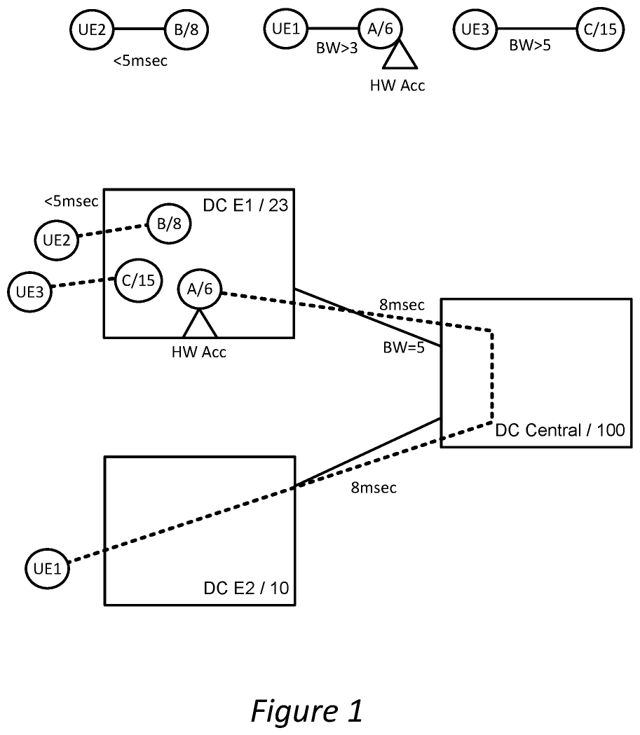

FIG. 1 illustrates an example placement of three services (A, B, and C) onto three distributed resource nodes, which are illustrated as data centers (DCs) in a non-limiting manner and referenced as DC E1, DC E2, and DC Central. FIG. 1 is now referenced to explain why the three services (A, B, and C) cannot be placed in any way on three DCs in any way that would avoid violating an operating constraint of at least one of the three services (A, B, and C).

Referring to FIG. 1, service A has an operating constraint of needing hardware acceleration, 6 CPUs, and communication bandwidth larger than 3 Gbps. Service B has an operating constraint of needing 8 CPUs and has a need for communication latency with UE2 to preferably not exceed 5 msec. Service C as an operating constraint for a bandwidth larger than 5 Gbps and needs 15 CPUs.

FIG. 1 also illustrates the available bandwidth of each DC and communication latency between the DCs. Edge 1 (DC E1) has 23 CPUS and hardware accelerator capability. Edge 2 (DC E2) has 10 CPUs. DC central has 100 CPUs. There is an 8 m second communication latency between the DC E1 and DC central, and between DC E2 and DC central.

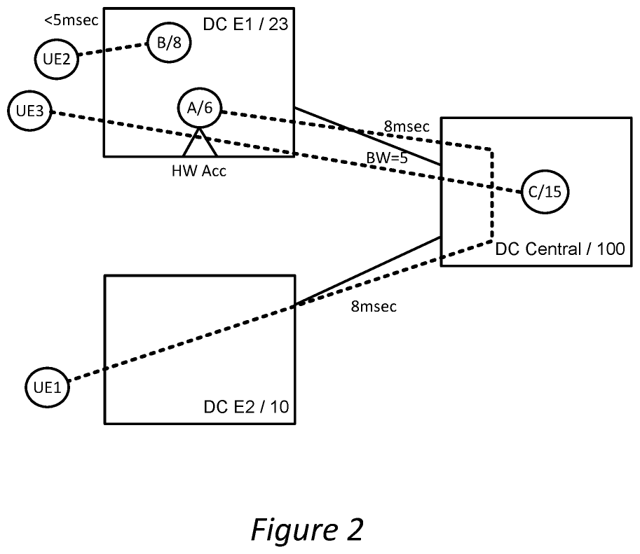

It is noted in this example that there appears to be no feasible placement solution without violating any of the constraints. For instance, as shown in FIG. 1, in a first scenario placing the three services (A, B, C) on DC E1 would violate the CPU requirements of one of the services. More particularly, the CPU requirements of one of the services would be violated because the total CPU requirements of the three services is 29, which is greater than the available CPUs of DC E1. FIG. 2 illustrates an alternative placement of services A and B placed on DC E1 and service C placed on DC Central, and which would then violate the bandwidth requirement of service C.

Below is a list of possible placements (indicated by, e.g., “A@E1” meaning service A placed on DC D1) of the three services along with their violations:
A@E1 & B@E1 & C@Central: results in bandwidth violation
A@E1 & B@E1 & C@E1: results in CPU violation
A@Central & B@E1 & C@E1: results in hardware accelerator violation
A@E1 & B@Central & C@E1: results in latency violation
A@E1 & B@E2 & C@Central: results in latency and BW violation

Accordingly, there is no feasible solution with the given constraints and the site's capability. In such cases, to find a feasible solution, constraint violation is inevitable.

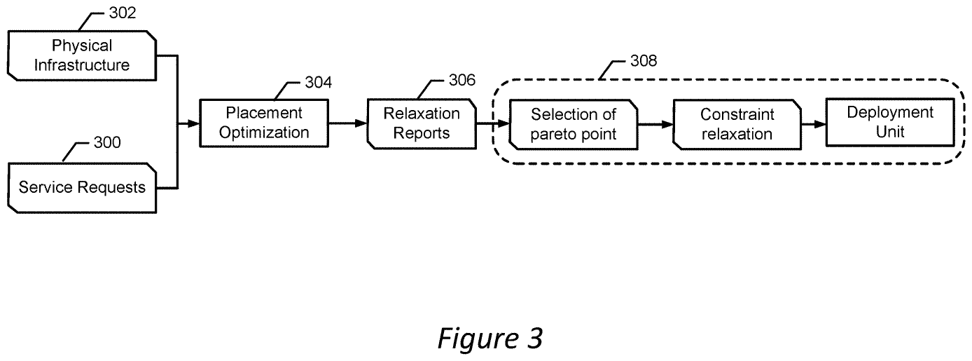

FIG. 3 illustrates a high-level operational flow including placement optimization, generation of relaxation reports, and example uses of the reports in accordance with some embodiments. Referring to FIG. 3, the operations can include to obtain 300 operating constraints for the services, and obtain 302 node resource information identifying resources of the distributed resource nodes (e.g., physical resources such as processing resources, network resources, etc.). A placement algorithm performs at attempt at placement optimization 304 and which may output relaxation reports 306. The relaxation reports may provide recommendations of constraint relaxation (that can be adjustment on resource constraint (by operators or by computer operations) and/or on requirement constraint (by customers or by other computer operations)). With constraint relaxations, a corresponding placement solution is generated and sent to a deployment unit to perform the deployment plan indicated in the report. Constraint relaxation can be performed according to the selection of Pareto point. The resulting deployment option with respect to the relaxation is then sent to deployment unit.

The resource information can indicate any type of capabilities of nodes which are available for operation of a service. Non-limiting examples of such indications include, processing bandwidth, number of processors, types of processors, speed of processor(s), amount of memory, types of memories, speed of memories, network speed, network latency, etc.

In some embodiments, the operations determine whether the services can be placed on the distributed resource nodes based on the node resource information without violating any of the operating constraints for the services. Based on determining the services cannot be placed on the distributed resource nodes without violating any of the operating constraints for the services, the operations generate 308 relaxed operating constraints of the services based on applying penalty values to change values of the operating constraints, where different penalty values are applied to each one of the operating constraints. The operations may optionally also determine 308 a candidate placement of the services on the distributed resource nodes based on the node resource information and the relaxed operating constraints of the services, which may include selection of a Pareto point from among trends in metrics. Pareto efficiency or Pareto optimality can refer to a situation where no individual performance metric can be better off without making at least one individual constraint worse off or without any loss thereof. The operations can generate 308 information identifying the candidate placement of which of the services on which of the distributed resource nodes and identifying which of the relaxed operating constraints of the services are violated by the candidate placement. The information can be used by a deployment unit to plan or initiate deployment of resources to the distributed resource nodes. Alternatively or additionally, the information can be used by the deployment unit to initiate reservation of operational resources of the distributed resource nodes for use during execution of the services according to the candidate placement, and initiate deployment of instances of the services to the distributed resource nodes according to the candidate placement.

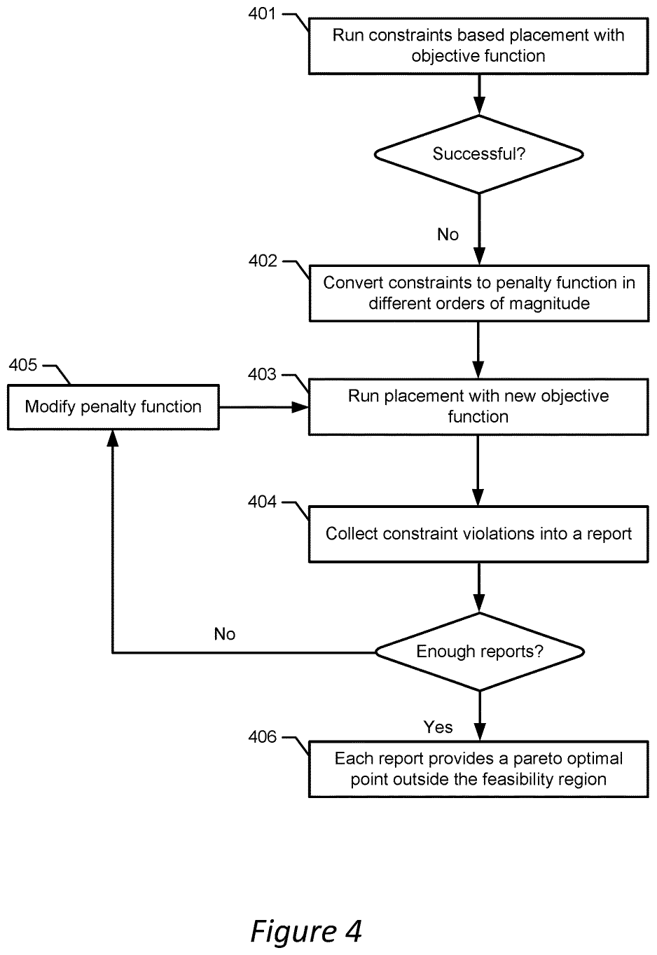

FIG. 4 illustrates a flowchart of operations that can generate a relaxation report for placement of services on distributed resource nodes (e.g., networked computing resources of data centers) in accordance with some embodiments.

Referring to FIG. 4, in operation 401, the placement algorithm runs with its current objective function and a set of constraints (e.g., latency, bandwidth, hardware (HW) acceleration capabilities, etc.). The objective function defines at least one type of resource capability of the distributed resource nodes that is to be maximized or minimized when planning placement of services on the distributed resource nodes. Example types of resource capabilities that can be defined by objective functions include, without limitation, maximizing processing bandwidth, minimizing communication latency, minimalizing memory utilization, minimizing HW acceleration utilization, etc., when planning placement of service(s) on distributed resource nodes.

In operation 402, if the placement algorithm does not find a feasible solution (e.g., a placement solution satisfying all of the set of constraints), the placement algorithm imposes a penalty on the constraints, e.g., in different orders of magnitude. This allows converting hard constraints into soft constraints and finding a feasible solution in different constraint spaces. Hard constraints are the constraints that are required to be satisfied at all times. In contrast, soft constraints are the constraints that are satisfied as much as possible and if not satisfied they are penalized in the objective function.

In operation 403, the placement algorithm performs another cycle with the new (modified or relaxed) objective function which includes the penalty functions. These operations can be performed within the placement optimization unit 304 of FIG. 3. Although it is not explicitly depicted in FIG. 3, the placement algorithm can perform multiple cycles of determining placement solutions, such as illustrated in FIG. 4.

In operation 404, the placement algorithm collects the violation of the constraints per objective function. These constraint violation reports identify deployment options with respect to different sets and level of constraint violations.

In operation 405, if more reports need to be generated in order to satisfy a defined rule, e.g., more permutations of inputs are to be run through the placement algorithm and/or there are not enough reports, then the placement algorithm modifies the orders of magnitude of the penalty imposed on the constraints and runs the placement algorithm again with the new (further modified or relaxed) objective function (the detail of this operational step is explained below).

In operation 406, each report may provide a Pareto optimal point outside the feasibility region. The constraint violation reports may be used to select one of the Pareto points outside of the feasibility region for deployment. The selection can be based on any one or more of: user preferences, defined policies, learned policies, service level agreements (e.g., to minimize cost of penalties due to service degradation), and/or operational policies (e.g., what quality of experience (QoE) to prioritize over what other QoE). The constraint violation reports may be used as indication of recommendation for resource upgrade locations is given or executed if operation runs on top of some flexible underlays (e.g., scaling up processing (computational) and/or networking resources provided by a leased cloud facility or other distributed resource nodes).

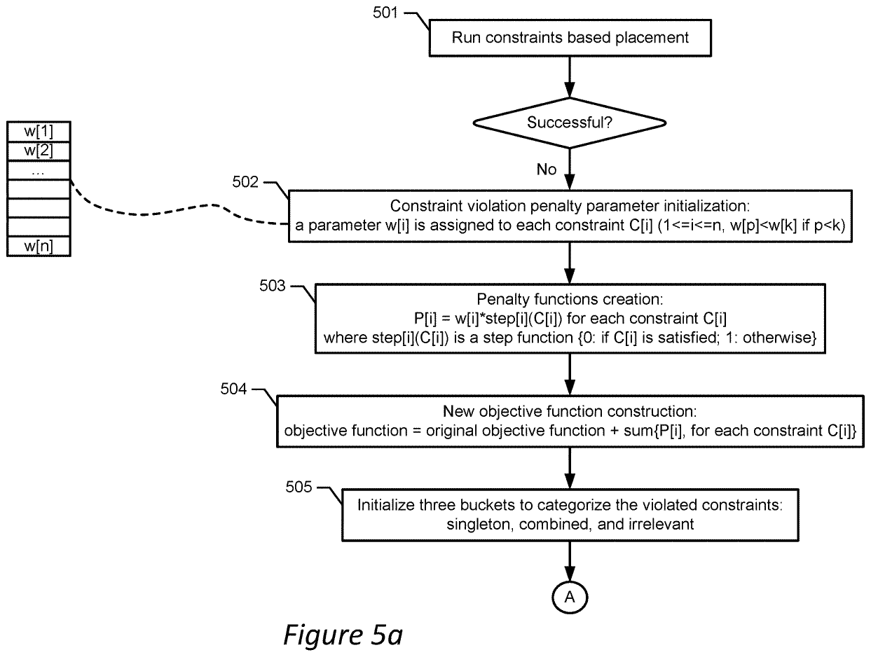

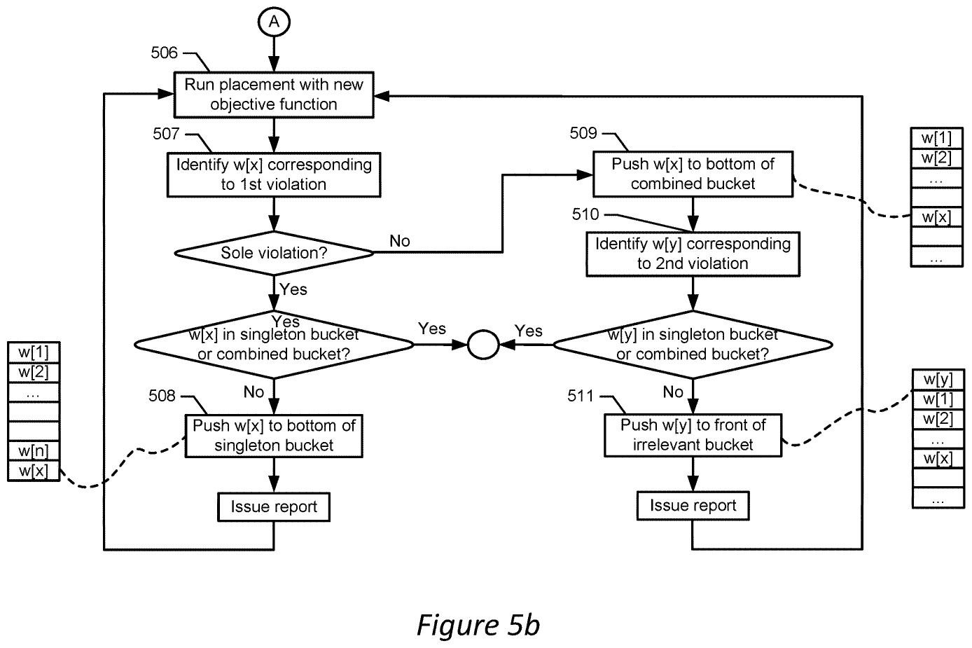

FIGS. 5A and 5B are combined to illustrate a more detailed flowchart of operations that can generate reports for placement of services on distributed resource nodes in accordance with some embodiments.

Referring to FIGS. 5A and 5B, the operates starts in operation 501 by running a placement algorithm with a given objective function and a set of constraints.

In operation 502, if the placement algorithm does not find a feasible solution (e.g., a placement solution satisfying all of the set of constraints), the placement algorithm imposes a penalty on the constraints in different orders of magnitude. A constraint violation penalty parameter w[i] for each constraint C[i] is initialized and assigned, where 1=<i<=n. The penalty parameter at this stage is given randomly to all n constraints, such that w[p]<w[k] if p<k.

In one embodiment, the penalty parameters w[i] of each constraint can be given by: w[i]=|current_value[i]−threshold[i]|multiplied by a value z[i] to make the w[i] for each constraint in different order of magnitude.

The “|current_value[i]−threshold [i]|” returns the maximum of the two values, either 0, if no violation, or the violation amount of the constraint i. The penalty can be more severe by using higher orders of magnitude: “|current_value[i]−threshold [i]|\hat{ }2”, [where threshold=constraint] and so on. It is noted that the above squaring “\hat{ }2” is optional.

The multiplication value z[i] for each constraint i is selected such that the penalty parameters of the constraints fall under a different range of magnitudes. One example could be giving z[i] the value of 10, 100, 1000, etc., such that z[p]<z[k] if p<k. An example array of penalty parameters w[i] is provided below:

w[1]
w[2]
. . .
w[n]

In operation 305, the penalty function P[i] is created. Where P[i]=w[i]*step[i] (C[i]). The step[i](C[i]) is a step function, it is equal to 0 if constraint C[i] is satisfied, and 1 if it is not satisfied.

In operation 306, the objective function is then modified, and a new objective function is constructed which includes the constraints' penalty function, e.g., which be based on below:

new objective function=original objective function+sum {P[i], for each constraint C[i]}

In operation 505, in order for the solution to provide reports, three buckets may be initialized at this step to allow categorizing of the constraints: singleton, combined, and irrelevant buckets. The singleton bucket includes a list of constraints that can alone solve the problem. Meaning that, by violating a constraint from the singleton bucket, a feasible solution can be found. The combined bucket includes a list of constraints that cannot alone solve the problem and need to be combined with other constraints from the combined or the singleton bucket to generate a feasible solution. The irrelevant bucket includes a list of constraints that by violating them (whether alone or combined with other constraints) cannot find any feasible solution.

In operation 506, the placement algorithm runs again with the new objective function.

In operation 507, the constraint x and its penalty parameter w[x] are identified corresponding to the first violation.

In operation 508, if the first violation is the sole violation and it is not categorized in any of the buckets, the algorithm pushes w[x] to the bottom of the singleton bucket and issues a report with this information, indicating that by violating the corresponding constraint and paying corresponding tradeoff (w[x]), a feasible solution can be achieved. This indicates that by violating constraint x alone, a feasible solution can be found for the placement algorithm. By pushing w[x] to the bottom, a higher penalty parameter w[x] is assigned to it which allows exploring the search space for the other constraints in the next steps.

An example array of penalty parameters w[i] in which w[x] is “pushed” to the bottom is provided below:

w[1]
w[2]
. . .
w[n]
w[x]

In operation 509, if constraint x is not the sole violation, the operations push it to the bottom of the combined bucket list. This allows exploring different feasibility regions in the next steps. An example array of penalty parameters in which w[x] is “pushed” to the bottom of the combined bucket list is provided below:

w[1]
w[2]
. . .
w[x]
. . .

In operation 510, the constraint y and its penalty parameter w[y] are identified as corresponding to the second violation.

In operation 511, if w[y] is not categorized in any of the buckets, it is pushed to the front of the irrelevant bucket, and a report is issued. In this report, all violated constraints (more than one), as well as the corresponding trade-offs, are included. Pushing w[y] to the front means giving it a high penalty parameter which allows exploring if a feasible solution can be found by violating constraint y. An example array of penalty parameters in which w[y] is “pushed” to the front of the irrelevant bucket is provided below:

w[y]
w[1]
w[2]
. . .
w[x]
. . .

The operations can now repeat begin at operation 506 to again run the placement algorithm with the different penalty parameters assigned to the constraints in operations 508, 509, and 511.

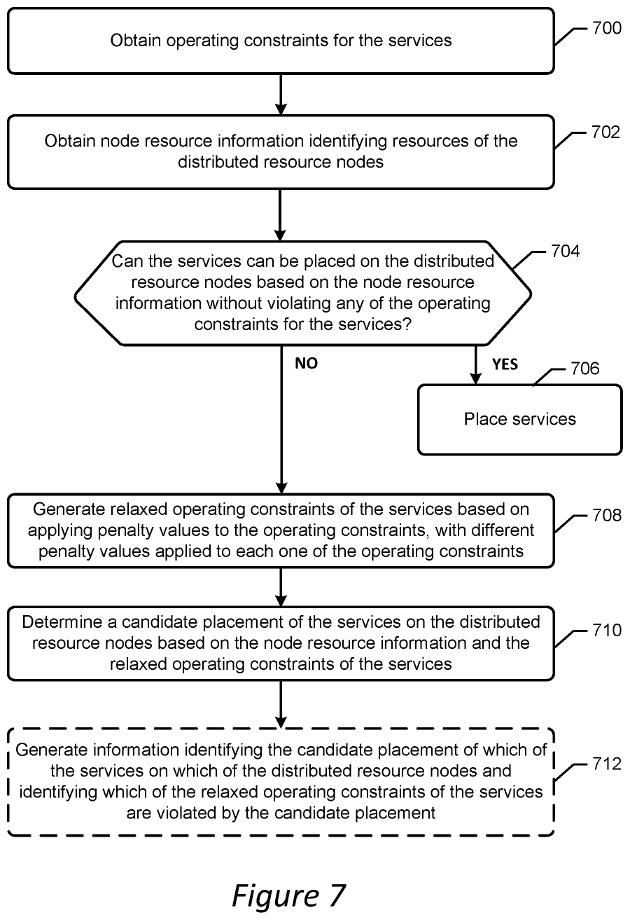

Some of the above embodiments have been described with reference the flowcharts of FIGS. 4, 5A, and 5B. However, the embodiments are not limited to the particular operations illustrated in those figures and can involve a subset of those operations and can be performed more generally. Some more general operations that can be performed in accordance with some embodiments are now described with reference to FIG. 7. FIG. 7 illustrates a flowchart of operations that can be performed by a service placement node in accordance with some embodiments.

Referring to FIG. 7, operations for determining placement of services onto distributed resource nodes, can include to obtain 700 operating constraints for the services, and obtain 702 node resource information identifying resources of the distributed resource nodes. The operations determine 704 whether the services can be placed on the distributed resource nodes based on the node resource information without violating any of the operating constraints for the services.

Based on determining 704 the services can be placed on the distributed resource nodes without violating any of the operating constraints for the services, the operations may place 706 the services. Placement 706 of the services may include providing information in reports used for planning and/or may include reserving operational resources of the distributed resource nodes for use during execution of the services according to the candidate placement and/or initiating deployment of instances of the services to the distributed resource nodes according to the placement.

In contrast, based on determining 704 the services cannot be placed on the distributed resource nodes without violating any of the operating constraints for the services, the operations generate 708 relaxed operating constraints of the services based on applying penalty values to change values of the operating constraints, wherein different penalty values are applied to each one of the operating constraints. In one example operation, a relaxed operating constraint for a service is generated by applying a penalty value to increase the value of a communication latency identified as an operating constraint for the service, so that the greater communication latency (relaxed operating constraint) is allowed to occur when determining placement of the service on distributed resource nodes. In another example operation, another relaxed operating constraint for the service is generated by applying another penalty value to decrease the number of processors identified by an operating constraint for the service, so that a fewer number of processors (relaxed operating constraint) is required to be available when determining placement of the service on distributed resource nodes. In still another example operation, another relaxed operating constraint for the service is generated by applying another penalty value to remove a requirement for hardware acceleration capabilities that was identified by an operating constraint for the service, e.g., by changing a binary flag from a positive indication to a negative indication of hardware acceleration capabilities being required, so that the service can be placed on a distributed resource node that does not have hardware acceleration capabilities.

Also based on the determination 704, the operations determine 710 a candidate placement of the services on the distributed resource nodes based on the node resource information and the relaxed operating constraints of the services.

In an optional further embodiment, the operations generate 712 information identifying the candidate placement of which of the services on which of the distributed resource nodes and identifying which of the relaxed operating constraints of the services are violated by the candidate placement.

In a further embodiment, the operation to determine 704 the candidate placement of the services, includes to obtain an objective function, process the objective function, the relaxed operating constraints of the services, and the node resource information through a placement algorithm to generate possible placements of services on distributed resource nodes. Operation further includes to select the candidate placement from among the possible placements based on the candidate placement most closely satisfying the objective function. The operation to select the candidate placement from among the possible placements may be based on a combination of the candidate placement most closely satisfying the objective function and minimizing violation of the relaxed operating constraints of the services.

In a further embodiment, operations repeat each of the following: the generating 708 of new relaxed operating constraints of the services based on applying the penalty values to the operating constraints, where a mapping between which of the penalty values are applied to which of the operating constraints is changed for each repetition; the determining 710 of a new candidate placement of the services on the distributed resource nodes based on the node resource information and the new relaxed operating constraints of the services; and the generating 712 of new information identifying which of the services are placed on which of the distributed resource nodes and identifying which of at least one the new relaxed operating constraints of the services is violated by the new candidate placement.

The violated at least one of the new relaxed operating constraints may be indicated in the information to have a lowest importance relative to the other new relaxed operating constraints when further determining which of the services can be placed on which of the distributed resource nodes.

The repetitions may be performed for each permutation of mapping between which of the penalty values are applied to which of the operating constraints.

The repetitions may be performed using an objective function that is modified over each of the repetitions based on the new relaxed operating constraints of the services. For each of the repetitions performed, the determining 710 of the new candidate placement of the services on the distributed resource nodes is based on: the node resource information; based on the new relaxed operating constraints of the services; and based on the objective function used for the repetition, and includes processing the objective function used for the repetition, the new relaxed operating constraints of the services, and the node resource information through a placement algorithm to generate possible placements of services on the distributed resource nodes, and then selecting the new candidate placement from among the possible placements based on the new candidate placement most closely satisfying the objective function. In a further embodiment, the penalty values have different orders of magnitude.

In a further embodiment, a constraint violation report is provided that contains the information. The constraint violation report may, for example, be communicated from the service placement node to a planning computer, planning personnel, and/or to other nodes. Alternatively or additionally, the operations may initiate reservation of operational resources of the distributed resource nodes for use during execution of the services according to the candidate placement, and/or may initiate deployment of instances of the services to the distributed resource nodes according to the candidate placement.

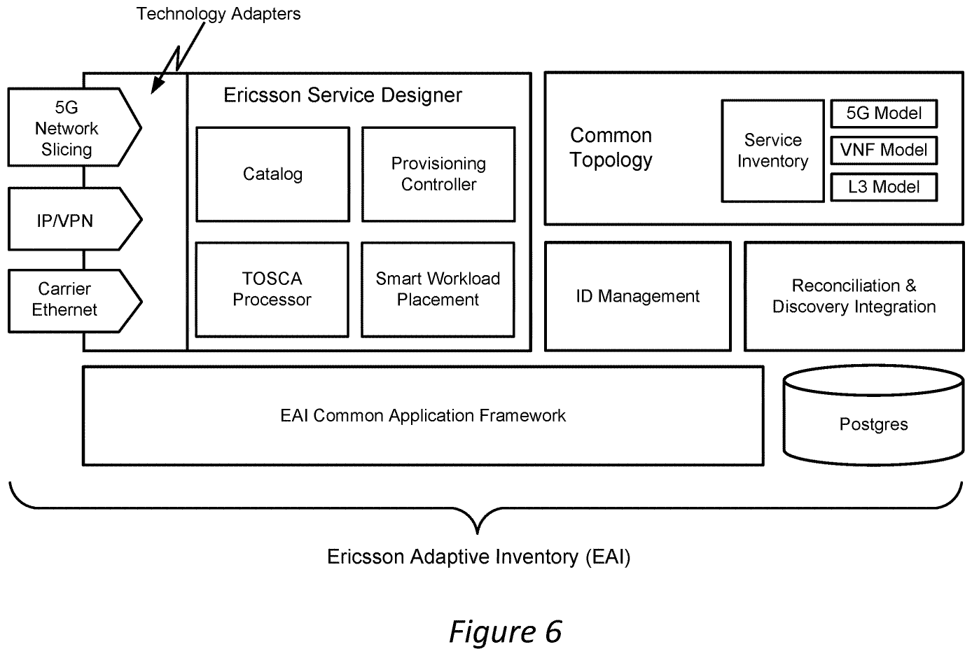

FIG. 6 illustrates a non-limiting example system in which operations disclosed herein may be performed in accordance with some embodiments. The example system can correspond to an Ericsson Adaptive Inventory (EAI) system. The EAI system includes technology adapters which obtain node resource information relating to, for example, 5G network slicing, IP/VPN, carrier Ethernet, etc. An Ericsson Service Designer (ESD) can include a catalog module, a provisioning controller module, a Topology and Orchestration Specification for Cloud Applications (TOSCA) module, and a smart workload placement module. The ESD is a framework for building technology-specific automation for service design and assignment.

The catalog module may be a repository of node resource information identifying resources of the distributed resource nodes and/or operating constraints information for services.

A common topology module can include a service inventory repository which include 5G model, virtual network functions (VNFs), and L3 model. An Ericsson Adaptive Inventory (EIA) common application framework, ID management module, and reconciliation and discovery integration module may be included in the system.

The smart workload placement module can access information provided by the EAI system and operate according to one or more of the embodiments disclosed herein to determine a candidate placement of the services to use resources available on distributed resource nodes.

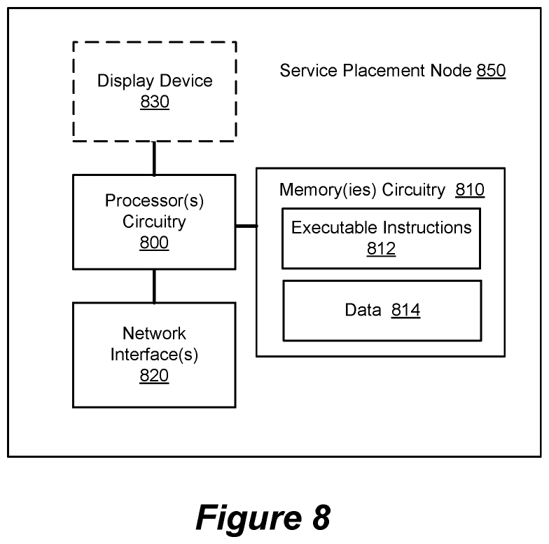

FIG. 8 illustrates a block diagram of components of a service placement node 850 which are configured to operate in accordance with some embodiments. The service placement node 800 includes at least one processor 800 (processor), at least one memory 810 (memory), and at least one network interface 820 (network interface). The service placement node 800 may further include a display device 830, user input interfaces, etc. The processor 800 is operationally connected to these various components. The memory 810 stores executable instructions 812 that are executed by the processor 800 to perform operations. The memory 810 may include a hierarchy of types of memories, e.g., processor cache memory, random access memory, solid-state drive, disk drive, etc. for storing instructions 812 and data 814. The processor 800 may include one or more data processing circuits, such as a general purpose and/or special purpose processor (e.g., microprocessor and/or digital signal processor), which may be collocated or distributed across one or more data networks. The processor 800 is configured to execute the instructions 812 in the memory 810, described below as a computer readable medium, to perform some or all of the operations and methods for one or more of the embodiments disclosed herein.

Further definitions and embodiments are now explained below.

In the above description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item and is not intended to be limiting of such item. The common abbreviation “i.e.”, which derives from the Latin phrase “id Est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the appended examples of embodiments are intended to cover all such modifications, enhancements, and other embodiments, which fall within the spirit and scope of present inventive concepts. Thus, to the maximum extent allowed by law, the scope of present inventive concepts is to be determined by the broadest permissible interpretation of the present disclosure including the following examples of embodiments and their equivalents and shall not be restricted or limited by the foregoing detailed description.

A listing of abbreviations used herein are defined below:

### Abbreviation Explanation

BW Bandwidth
CSP Constraint Satisfaction Problem
DC Data-Center
EIA Ericsson Adaptive Inventory
ESD Ericsson Service Designer
GDS Guarded Discrete Stochastic
HW Hardware
MAX-CSP Maximal Constraint Satisfaction Problem
NP Non-deterministic Polynomial-time
TOSCA Topology and Orchestration Specification for Cloud Applications
VNF Virtual Network Functions

The following listing of documents are referenced herein by their bracketed number:
[1] Minton, Steven, et al. “Solving Large-Scale Constraint-Satisfaction and Scheduling Problems Using a Heuristic Repair Method.” AAAI. Vol. 90. 1990.
[2] Wu F, Jennings N. Regret-based multi-agent coordination with uncertain task rewards. In Proceedings of the AAAI Conference on Artificial Intelligence 2014 Jun. 21 (Vol. 28, No. 1).
[3] EP1400905A1, Method and apparatus for adaptively determining weight factors within the context of an objective function
[4] U.S. Pat. No. 7,277,960B2, incorporating constraints and preferences for determining placement of distributed application onto distributed resource infrastructure

1. A method of determining placement of services onto distributed resource nodes, comprising:
obtaining operating constraints for the services;
obtaining node resource information identifying resources of the distributed resource nodes;
determining whether the services can be placed on the distributed resource nodes based on the node resource information without violating any of the operating constraints for the services; and
based on determining the services cannot be placed on the distributed resource nodes without violating any of the operating constraints for the services,
generating relaxed operating constraints of the services based on applying penalty values to change values of the operating constraints, wherein different penalty values are applied to each one of the operating constraints, and
determining a candidate placement of the services on the distributed resource nodes based on the node resource information and the relaxed operating constraints of the services.

2. The method of claim 1, wherein the determining of the candidate placement of the services on the distributed resource nodes based on the node resource information and the relaxed operating constraints of the services, comprises:
obtaining an objective function defining at least one type of resource capability of the distributed resource nodes that is to be maximized or minimized when planning placement of services on the distributed resource nodes;
processing the objective function, the relaxed operating constraints of the services, and the node resource information through a placement algorithm to generate possible placements of services on the distributed resource nodes; and
selecting the candidate placement from among the possible placements based on the candidate placement most closely satisfying the objective function.

3. The method of claim 2, wherein the selecting of the candidate placement from among the possible placements is based on a combination of the candidate placement most closely satisfying the objective function and minimizing violation of the relaxed operating constraints of the services.

4. The method of claim 1, further comprising:
generating information identifying the candidate placement of which of the services on which of the distributed resource nodes and identifying which of the relaxed operating constraints of the services are violated by the candidate placement

5. The method of claim 4, further comprising repeating each of the following:
the generating of new relaxed operating constraints of the services based on applying the penalty values to the operating constraints, wherein a mapping between which of the penalty values are applied to which of the operating constraints is changed for each repetition;
the determining of a new candidate placement of the services on the distributed resource nodes based on the node resource information and the new relaxed operating constraints of the services, and
the generating of new information identifying which of the services are placed on which of the distributed resource nodes and identifying which of at least one the new relaxed operating constraints of the services is violated by the new candidate placement.

6. The method of claim 5, wherein the violated at least one of the new relaxed operating constraints is indicated in the information to have a lowest importance relative to the other new relaxed operating constraints when further determining which of the services can be placed on which of the distributed resource nodes.

7. The method of claim 5, wherein the repetitions are performed for each permutation of mapping between which of the penalty values are applied to which of the operating constraints.

8. The method of claim 5, wherein:
the repetitions are performed using an objective function that is modified over each of the repetitions based on the new relaxed operating constraints of the services; and
for each of the repetitions performed, the determining of the new candidate placement of the services on the distributed resource nodes is based on the node resource information, based on the new relaxed operating constraints of the services, and based on the objective function used for the repetition, and comprises
processing the objective function used for the repetition, the new relaxed operating constraints of the services, and the node resource information through a placement algorithm to generate possible placements, and then selecting the new candidate placement from among the possible placements based on the new candidate placement most closely satisfying the objective function.

9. The method of claim 1, wherein the penalty values have different orders of magnitude.

10. The method of claim 1, further comprising:
providing a constraint violation report containing the information.

11. The method of claim 1, further comprising:
initiating reservation of operational resources of the distributed resource nodes for use during execution of the services according to the candidate placement; and
initiating deployment of instances of the services to the distributed resource nodes according to the candidate placement.

12. A service placement node, comprising:
at least one processor; and
at least one memory storing instructions executable by the at least one processor to perform operations to:
obtain operating constraints for the services;
obtain node resource information identifying resources of distributed resource nodes;
determine whether the services can be placed on the distributed resource nodes based on the node resource information without violating any of the operating constraints for the services; and
based on determining the services cannot be placed on the distributed resource nodes without violating any of the operating constraints for the services,
generate relaxed operating constraints of the services based on applying penalty values to change values of the operating constraints, wherein different penalty values are applied to each one of the operating constraints, and
determine a candidate placement of the services on the distributed resource nodes based on the node resource information and the relaxed operating constraints of the services.

13. The service placement node of claim 12, wherein the operation to determine the candidate placement of the services on the distributed resource nodes based on the node resource information and the relaxed operating constraints of the services, comprise to:
obtain an objective function defining at least one type of resource capability of the distributed resource nodes that is to be maximized or minimized when planning placement of services on the distributed resource nodes;
process the objective function, the relaxed operating constraints of the services, and the node resource information through a placement algorithm to generate possible placements of services on the distributed resource nodes; and
select the candidate placement from among the possible placements based on the candidate placement most closely satisfying the objective function.

14. The service placement node of claim 13, wherein the operation to select the candidate placement from among the possible placements is based on a combination of the candidate placement most closely satisfying the objective function and minimizing violation of the relaxed operating constraints of the services.

15. The service placement node of claim 12, wherein the operations further comprise to:
generate information identifying the candidate placement of which of the services on which of the distributed resource nodes and identifying which of the relaxed operating constraints of the services are violated by the candidate placement

16. The service placement node of claim 15, wherein the operations further comprise to repeat each of the following:
the operation to generate new relaxed operating constraints of the services based on applying the penalty values to the operating constraints, wherein a mapping between which of the penalty values are applied to which of the operating constraints is changed for each repetition;
the operation to determine a new candidate placement of the services on the distributed resource nodes based on the node resource information and the new relaxed operating constraints of the services, and
the operation to generate new information identifying which of the services are placed on which of the distributed resource nodes and identifying which of at least one the new relaxed operating constraints of the services is violated by the new candidate placement.

17. The service placement node of claim 16, wherein the violated at least one of the new relaxed operating constraints is indicated in the information to have a lowest importance relative to the other new relaxed operating constraints when further determining which of the services can be placed on which of the distributed resource nodes.

18. The service placement node of claim 16, wherein the repetition of the operations is performed for each permutation of mapping between which of the penalty values are applied to which of the operating constraints.

19. The service placement node of claim 16, wherein:
the repetition of the operations is performed using an objective function that is modified over each of the repetitions based on the new relaxed operating constraints of the services; and
for each of the repetition of operations that is performed, the determining of the new candidate placement of the services on the distributed resource nodes is based on the node resource information, based on the new relaxed operating constraints of the services, and based on the objective function used for the repetition, and comprises operations to
process the objective function used for the repetition, the new relaxed operating constraints of the services, and the node resource information through a placement algorithm to generate possible placements, and then select the new candidate placement from among the possible placements based on the new candidate placement most closely satisfying the objective function.

20. The service placement node of claim 12, wherein the penalty values have different orders of magnitude.

21-22. (canceled)
